(19) United States
(12) Patent Application Publication
(10) Pub. No.: US 2026/0138124 A1
(43) Pub. Date: May 21, 2026

(54) Production Method for Exhaust Gas Purification Catalyst and Chemical Solution Plate used in said Production Method

(71) Applicant: Cataler Corporation, Kakegawa-Shi (JP)

(72) Inventors: Koki Shibata, Kakegawa-Shi (JP); Kenta Inamori, Kakegawa-Shi (JP)

(21) Appl. No.: 18/849,772

(22) PCT Filed: Mar. 2, 2023
(86) PCT No.: PCT/JP2023/007816

§ 371 Date: Jul. 7, 2025

(30) Foreign Application Priority Data
Mar. 30, 2022 (JP) 2022-057214

(51) Int. Cl. B01J 37/02; B01D 53/94; B01J 23/42; B01J 23/44; B01J 23/46; B01J 35/57; C23C 18/08; F01N 3/28

(52) U.S. Cl. CPC B01J 37/0215; B01D 53/94; B01J 23/42; B01J 23/44; B01J 23/464; B01J 35/57; C23C 18/08; F01N 3/2803; B01D 2255/1021; B01D 2255/1023; B01D 2255/1025; B01D 2255/9155; B01D 2257/404; B01D 2257/502; B01D 2257/702; B01D 2258/01; F01N 2370/02; F01N 2510/06

(57) ABSTRACT

The present disclosure provides a technology of reducing waviness of a carrying width of a catalyst metal carrying portion in an exhaust gas purification catalyst. A method disclosed herein includes: preparing a base material having an exhaust gas passage; preparing a catalyst metal solution containing a catalyst metal oxidizing or reducing exhaust gas component; supplying the catalyst metal solution to a chemical solution plate so that a bottom surface of the chemical solution plate is not exposed; immersing an end of the base material in the catalyst metal solution supplied to the chemical solution plate; and firing the base material. The bottom surface of the chemical solution plate is provided with grooves in a predetermined pattern, and an average of depths of the grooves is from 1.2 mm to 3 mm inclusive, and an average of widths of the grooves is from 1.6 mm to 3 mm inclusive.

### TECHNICAL FIELD

The present invention relates to a method for producing an exhaust gas purification catalyst and a chemical solution plate used in the method. The present application is based upon and claims the benefit of priority from Japanese patent application No. 2022-057214 filed on Mar. 30, 2022, and the entire disclosure of which is incorporated herein its entirety by reference.

### BACKGROUND ART

The exhaust gas exhausted from the internal combustion engine contains hazardous components such as carbon monoxide (CO), hydrocarbon (HC), and nitrogen oxide (NOx). Exhaust gas purification catalysts for purifying these hazardous components are placed in exhaust passages of internal combustion engines. The exhaust gas purification catalyst includes, for example, a base material having a honeycomb structure in which multiple gas flow paths (cells) are partitioned by partition walls, and a catalyst metal carrying portion provided on the surfaces of and/or inside the partitions of the base material and includes a catalyst metal (e.g., palladium (Pd), rhodium (Rh), and platinum (Pt)) which purifies exhaust gas components by oxidation or reduction.

For example, in Patent Literature 1, a technology of immersing the entire base material (also referred to as a wash coat carrier) in a noble metal solution with which a container is filled to cause the noble metal to be carried on the base material. In the container, the bottom of a depression in which the base material is housed is provided with multiple recesses, and high-concentration noble metal portions corresponding to the recesses can be formed in the base material.

### CITATION LIST

### Patent Literature

Patent Literature 1: Japanese Patent Application Publication No. 2003-334444

### SUMMARY OF INVENTION

In recent years, a technology in which the catalyst metal carrying portion is formed not in the entire base material but in a predetermined area to improve characteristics of the exhaust gas purification catalyst has been focused on. Hence, the present inventors consider conducting a technology of preparing a defined amount of the catalyst metal solution (e.g., a noble metal solution) on a chemical solution plate, immersing an end of the base material in the catalyst metal solution, and introducing the catalyst metal solution into exhaust gas passage of the base material. In such a technology, the catalyst metal solution can be introduced into the exhaust gas passage of the base material by capillary phenomenon. However, the surface tension of the catalyst metal solution is high. Thus, when the amount of the catalyst metal solution prepared on the chemical solution plate becomes small, the catalyst metal solution is prone to be gathered in a center portion of the chemical solution plate, and the liquid surface is curved so that the portion near the center portion becomes high. This causes the tip surface of the catalyst metal solution introduced into the base material by the capillary phenomenon to be corrugated, and the width of the catalyst metal carrying portion (waviness of the carrying width) varies between the center portion of the base material and the outer peripheral portion of the base material.

The present disclosure was made to solve the problem and is intended mainly to provide a technology which can reduce waviness of the carrying width of the catalyst metal carrying portion in the exhaust gas purification catalyst. The present disclosure is intended to further provide a chemical solution plate which can characterize the technology.

In order to solve the problem, the present disclosure provides a method for producing an exhaust gas purification catalyst disclosed herein (hereinafter merely referred to as a “production method”).

The production method disclosed herein is a method for producing an exhaust gas purification catalyst which purifies exhaust gas exhausted from internal combustion engines. The production method disclosed herein includes: preparing a base material having an exhaust gas passage from an upstream end from which exhaust gas is introduced and a downstream end from which exhaust gas is exhausted: preparing a catalyst metal solution containing a catalyst metal functioning as a catalyst capable of oxidizing or reducing at least one exhaust gas component: supplying the catalyst metal solution to a chemical solution plate so that a bottom surface of the chemical solution plate is not exposed: immersing an upstream end or a downstream end of the base material in the catalyst metal solution supplied to the chemical solution plate to introduce the catalyst metal solution to an exhaust gas passage of the base material; and firing the base material into which the catalyst metal solution is introduced. The bottom surface of the chemical solution plate is provided with grooves in a predetermined pattern, and an average of depths of the grooves is from 1.2 mm to 3 mm inclusive, and an average of widths of the grooves is from 1.6 mm to 3 mm inclusive.

Here, the “exhaust gas passage” refers to a region where the exhaust gas introduced into the base material can flow, and is not limited to a space (cell) provided inside the base material. The inside (insides of the pores) of the porous material that constitutes the base material also constitutes part of the exhaust gas passage as long as exhaust gas is introduced and can flow.

With such a configuration, grooves are formed in the bottom surface of the chemical solution plate, so that the surface tension of the catalyst metal solution supplied to the chemical solution plate can be reduced, and the liquid surface of the catalyst metal solution supplied to the chemical solution plate can be kept from curving due to the surface tension. Accordingly, the end of the base material is immersed in the catalyst metal solution, and waviness of the end surface of the catalyst metal solution introduced into the base material is reduced. As a result, waviness of the carrying width in the catalyst metal carrying portion formed by firing can be reduced.

In a preferred aspect of the production method disclosed herein, a liquid surface height of the catalyst metal solution supplied to the chemical solution plate, from the bottom surface is 0.37 mm or more. With such a configuration, the curving of the liquid surface of catalyst metal solution supplied to the chemical solution plate can be reduced, so that waviness of the carrying width of the catalyst metal carrying portion can be reduced at high level.

In a preferred aspect of the production method disclosed herein, the grooves are formed to communicate with each other. With such a configuration, when the amount of the catalyst metal solution supplied to the chemical solution plate becomes small, the liquid surface heights of the catalyst metal solution inside the grooves become constant. Thus, waviness of the carrying width in the catalyst metal carrying portion is reduced.

In a preferred aspect of the production method disclosed herein, the grooves are formed in a lattice pattern. This allows further reduction in surface tension of the catalyst metal carrying portion, so that the waviness of the carrying width of the catalyst metal carrying portion can be reduced.

Further, in a preferred aspect, the grooves are formed at a predetermined pitch, and the pitch is from 8 mm to 20 mm inclusive. With such a configuration, in addition to the reduction in waviness of the carrying width in the catalyst metal carrying portion, the amount (remaining amount) of the catalyst metal solution remaining in the chemical solution plate becomes small, and the variation of the remaining amount is reduced. Thus, variation of the amount of catalyst metal carried on the base material can be further reduced.

The present disclosure further provides a chemical solution plate used in production of exhaust gas purification catalyst for purifying exhaust gas exhausted from internal combustion engines. The chemical solution plate disclosed herein has a depression made of a bottom wall and a side wall standing from the bottom wall. The surface of the bottom wall on the depression side is provided with grooves in a predetermined pattern, and an average of depths of the grooves is from 1.2 mm to 3 mm inclusive, and an average of widths of the grooves is from 1.6 mm to 3 mm inclusive.

### BRIEF DESCRIPTION OF DRAWINGS

FIG. 1 is a flowchart illustrating general steps of a production method for an exhaust gas purification catalyst according to an embodiment.

FIG. 2 is a schematic perspective view of an example of a configuration of a base material used in an exhaust gas purification catalyst.

FIG. 3 is a schematic cross-sectional view of a configuration where a catalyst metal solution is supplied to a chemical solution plate according to an embodiment.

FIG. 4 is a schematic plan view of a configuration of a chemical solution plate according to an embodiment.

FIG. 5 is a partial enlarged view of a configuration of a bottom surface of a chemical solution plate according to an embodiment.

FIG. 6A is a schematic view of a method for introducing a catalyst metal solution to a base material by using an example of a known chemical solution plate.

FIG. 6B is a schematic view of a method for introducing a catalyst metal solution to a base material by using an example of a known chemical solution plate.

FIG. 6C is a schematic view of a method for introducing a catalyst metal solution to a base material by using an example of a known chemical solution plate.

FIG. 7 is a graph showing an average remaining amount of catalyst metal solution in each Example and its variation σ.

### DESCRIPTION OF EMBODIMENTS

The following describes embodiments of the present disclosure with reference to the drawings. The matters necessary for executing the technology disclosed herein (e.g., a method for processing a chemical solution plate), except for matters specifically herein referred to can be grasped as design matters of those skilled in the art based on the related art in the preset field. The technology disclosed herein can be executed based on the contents disclosed herein and the technical knowledge in the present field. The drawings herein are intended to schematically show the contents of technology disclosed herein for better understanding, and the dimensional relation (such as length, width, or thickness) in each drawing does not reflect the actual dimensional relation. The expression “A to B (here A and B are any numerical values)” indicating herein a numerical range means “A or more to B or less,” and also means “above A to less than B,” “above A to B or less,” and “A or more to less than B.”

FIG. 1 is a flowchart illustrating general steps of a production method for an exhaust gas purification catalyst according to an embodiment. The present embodiment includes a material preparation step S10, an immersion step S20, a drying step S30, and a firing step S40.

### <Material Preparation Step S10>

The material preparation step S10 includes preparing a base material, a catalyst metal solution, and a chemical solution plate.

### (Base Material)

The base material is a member that constitutes a framework of the exhaust gas purification catalyst. As the base material, various materials in various forms that have been used as base materials that constitute the exhaust gas purification catalyst can be employed. For example, ceramic base materials such as cordierite, aluminum titanate, and silicon carbide (SiC) with high heat resistance, or metal base materials such as stainless steel can be used.

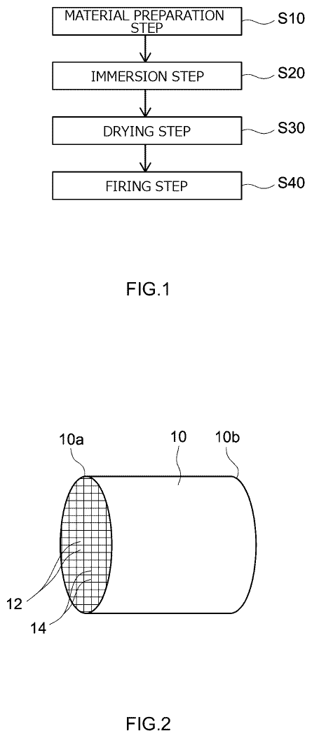

The shape of the base material can be the same as those of the known exhaust gas purification catalysts and is not particularly limited as long as the base material has an exhaust gas passage extending from the upstream end from which exhaust gas is introduced to the downstream end from which exhaust gas is exhausted. FIG. 2 is a schematic perspective view of an example of a configuration of a base material used in an exhaust gas purification catalyst. As shown in FIG. 2, the outside shape of the base material 10 may be cylindrical. The base material 10 includes multiple cells 12 in a major axis direction which are through holes as an exhaust gas passage, and the cells 12 have a honeycomb structure partitioned by the partitions (rib walls) 14. In FIG. 2, the shape of each cell 12 in the cross section perpendicular to the cylinder axis direction of the base material 10 is square, but is not particularly limited thereto. The shape may be, for example, any of various geometric shapes, namely a rectangle such as parallelogram, quadrangle, trapezoid: other polygons (e.g., triangle, hexagonal, octagonal); and circular. As for the outside shape of the entire base material 10, an elliptical cylindrical shape, a polygonal cylindrical shape, and the like may be employed instead of a cylindrical shape.

The base material 10 shown in FIG. 2 is of a so-called straight flow type in which exhaust gas introduced into the cells 12 from the upstream end 10a is exhausted from the downstream end 10b through the cells 12, but is not particularly limited. The base material 11 may be, for example, a so-called wall flow type base material in which exhaust gas introduced from the upstream end of the cells in which the upstream ends are only open passes through a porous partition, moves to adjacent cells in which the downstream ends are only open, and exhausted from the downstream ends of the cells. Alternatively, it may be a sponge-like porous material with irregular pores, as long as the exhaust gas can flow through the pores.

Although not particularly limited thereto, the capacity of the base material 10 (volume of all cells 12) is usually 0.1 L or more (preferably 0.5 L or more), for example, 5 L or less (preferably 3 L or less, more preferably 2 L or less). The overall length of the base material 10 along the exhaust gas flowing direction (cylinder axis direction) is usually about 10 mm to about 500 mm (e.g., 50 mm to 300 mm).

The cross-sectional area per a cell 12 in the cross section perpendicular to the cylinder axis direction of the base material 10 is, for example, from 0.6 mm² to 2.5 mm² inclusive, preferably from 0.8 mm² to 2.2 mm² inclusive. With such a range, the capillary phenomenon can be effectively caused while the exhaust gas distribution is ensured. When the capillary phenomenon is effectively caused, the catalyst metal solution can be highly efficiently introduced into the exhaust gas passage of the base material.

### (Catalyst Metal Solution)

The catalyst metal solution is a material used to form a catalyst metal carrying portion (also called a catalyst layer) having a function of purifying exhaust gas components on at least a surface of the partition facing the exhaust gas passage of the base material. The catalyst metal solution contains a catalyst metal functioning as a catalyst capable of oxidizing or reducing at least one exhaust gas component. The catalyst metal solution may contain a liquid medium.

Examples of the catalyst metal include noble metals belonging to platinum group elements such as palladium (Pd), rhodium (Rh), and platinum (Pt) or other metals that function as oxidization catalysts or reduction catalysts. Pd and Pt have excellent purifying performance (oxidation purifying performance) for carbon monoxide and hydrocarbon, and Rh has excellent purifying performance (reduction purifying performance) for NOx. Thus, they are particularly preferable catalyst metals.

The catalyst metal solution contains a catalyst metal preferably in a form of ion. Such a catalyst metal solution is fired, thereby forming catalyst metal particles. Further, the concentration of the catalyst metal in the catalyst metal solution can be uniform. Thus, a catalyst metal carrying portion in which catalyst metal particles are highly uniformly distributed can be formed even when the catalyst metal solution is introduced inside the base material by capillary phenomenon. The catalyst metal solution used can be, for example, an aqueous solution containing a water-soluble metal salt including a catalyst metal or an aqueous solution containing a complex of the catalyst metal. Examples of the metal salt include: nitrates such as palladium nitrate and rhodium nitrate; and sulfates such as palladium sulfate and rhodium sulfate. Examples of the complex of the catalyst metal include a tetraammine complex, a cyano complex, a halogeno complex, and a hydroxy complex.

The “catalyst metal solution” herein may encompass a mixture where colloid particles are dispersed in a medium. Thus, the catalyst metal may not be dissolved completely in a medium, and may be in a form of catalyst metal particles. Although not particularly limited thereto, the mean particle diameter of the catalyst metal particles may be, for example, about 0.1 nm to about 1 μm (typically 1 nm to 10 nm). The mean particle diameter can be determined as an average value obtained from measurement of particle diameters of 100 catalyst metal particles by observation using transmission electron microscopy.

As a medium which can be used in the catalyst metal solution, aqueous solvents (e.g., water, deionized water, pure water) can be suitably employed, for example. In the aqueous solvent, a metal salt and a catalyst metal complex each of which contains a catalyst metal can be suitably dissolved.

The catalyst metal solution may further contain other additives such as a thickener, a dispersant, a surfactant, and a binder as long as it is introduced into the base material by capillary phenomenon.

The content of the catalyst metal in the entire catalyst metal solution is, for example, 0.1 mass % to 30 mass %, or 1 mass % to 15 mass %. When the content of the catalyst metal is adjusted, the amount of the catalyst metal particles in the catalyst metal carrying portion can be adjusted. The content of the catalyst metal refers to a value converted to atomic weight of the catalyst metal.

### (Chemical Solution Plate)

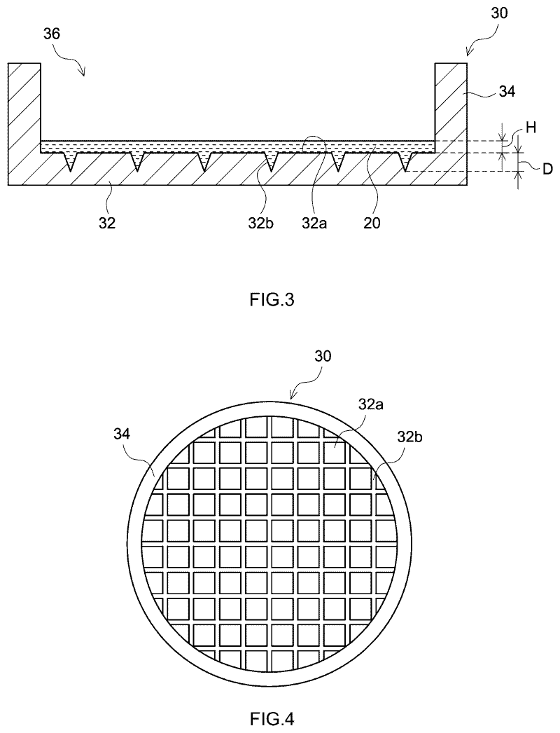

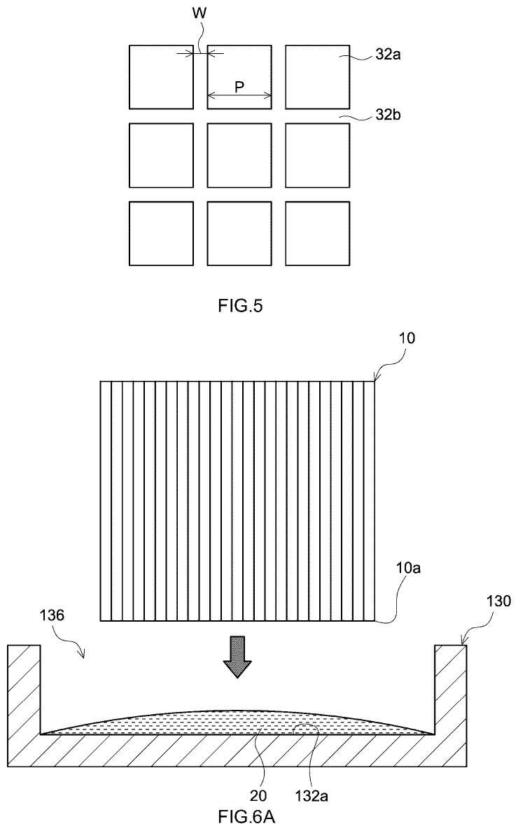

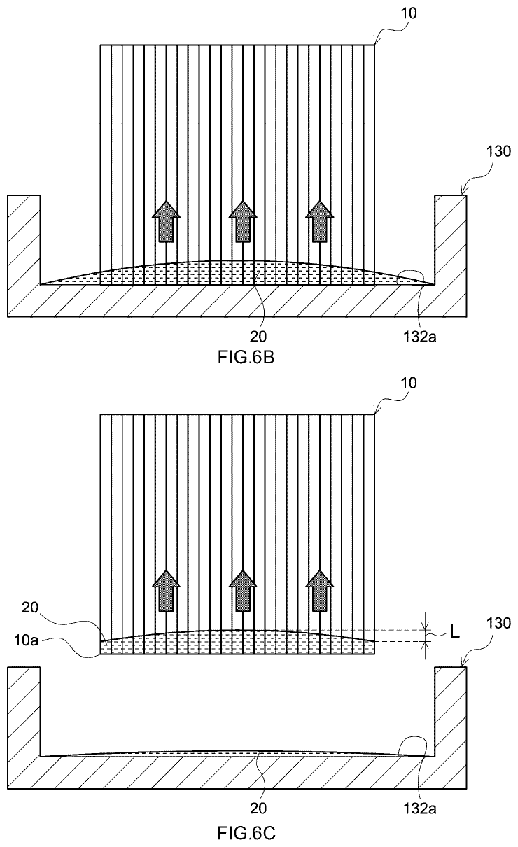

The chemical solution plate has a depression to which the catalyst metal solution can be supplied. FIG. 3 is a schematic cross-sectional view of a configuration where a catalyst metal solution is supplied to a chemical solution plate according to an embodiment. FIG. 4 is a schematic plan view of a configuration of a chemical solution plate according to an embodiment. FIG. 5 is a partial enlarged view of a configuration of a bottom surface of a chemical solution plate according to an embodiment. The chemical solution plate 30 includes a bottom wall 32 and a side wall 34 standing from the outer peripheral portion of the bottom wall 32 and includes a depression 36 made of the bottom wall 32 and the side wall 34. The surface (also referred to as a “bottom surface 32a”) of the bottom wall 32 of the chemical solution plate 30 on the depression 36 side is provided with grooves 32b in a predetermined pattern. The present technology is characterized by the grooves 32b. FIGS. 6A to 6C schematically show a method for introducing a catalyst metal solution 20 to the base material 10 using an example of the known chemical solution plate 130 and explain problems.

FIGS. 6A to 6C schematically show a method for introducing a catalyst metal solution 20 into the base material 10 (in detail, the exhaust gas passage of the base material 10) by immersing the end (here, the upstream end 10a) of the base material 10 in the catalyst metal solution 20. Such a method is conducted in order of FIGS. 6A, 6B, and 6C. As illustrated in FIGS. 6A to 6C, in the known chemical solution plate 130, the bottom surface 132a is not provided with grooves. When the catalyst metal solution 20 is supplied to the depression 136 of the chemical solution plate 130, the liquid surface height of the supplied catalyst metal solution 20 in the center portion becomes high due to the surface tension of the catalyst metal solution 20. In other words, the liquid level of the catalyst metal solution 20 is curved. When the end of the base material 10 is immersed in the catalyst metal solution 20 (see FIG. 6A), the catalyst metal solution 20 supplied to the chemical solution plate 130 is introduced into the exhaust gas passage (fine pores which may be in cells and partitions in the case of a honeycomb base material) of the base material 10 (see FIG. 6B). However, the liquid level of the catalyst metal solution 20 is curved. Thus, the catalyst metal solution 20 is brought into the state where the tip surface of the catalyst metal solution 20 introduced to the base material 10 is curved (waved). Then, in this state, the base material 10 is fired to form a catalyst metal carrying portion. Thus, the variation (waviness) of the carrying width (the width from the end of the base material 10 of the catalyst metal carrying portion is caused. As shown in FIG. 6C, the carrying width of the catalyst metal carrying portion near the center portion of the base material 10 becomes maximum, the carrying width of the catalyst metal carrying portion near the outer peripheral portion of the base material 10 becomes minimum, and the difference L between the maximum value and the minimum value of the catalyst metal carrying width is caused. When the difference L is large, the exhaust gas purification performance varies between the center portion and the outer peripheral portion of the base material, and desired exhaust gas purification performance may not be exhibited.

Even if the amount of the catalyst metal solution 20 is increased to prevent curving of the liquid level of the catalyst metal solution 20 supplied, the amount of the catalyst metal solution 20 in the chemical solution plate 130 becomes small with supply of the catalyst metal solution 20 into the base material 10. Thus, the liquid level of the catalyst metal solution 20 in the center portion becomes high. Thus, the adjustment of the amount of the catalyst metal solution 20 to be supplied is insufficient to reduce the waviness of the carrying width of the catalyst metal carrying portion.

In the chemical solution plate 30 disclosed herein, the bottom surface 32a is provided with grooves 32b in a predetermined pattern. Further, each groove 32b has a predetermined depth (e.g., an average of 1.2 mm to 3 mm) and a predetermined width (e.g., an average of 1.6 mm to 3 mm). When the grooves 32b are formed, the surface tension of the catalyst metal solution 20 supplied to the chemical solution plate 30 can be reduced. Thus, the liquid surface of the catalyst metal solution 20 can be kept from curving. Accordingly, the end of the base material 10 is immersed in the catalyst metal solution 20, and when the catalyst metal solution 20 is introduced into the base material 10 due to the capillary phenomenon, the waviness of the tip surface is reduced. As a result, waviness of the carrying width in the catalyst metal carrying portion can be reduced. Further, the surface tension of the catalyst metal solution is reduced by the grooves 32b. Thus, after the catalyst metal solution 20 is introduced into the base material 10 by using the capillary phenomenon, the amount of the catalyst metal solution 20 remaining on the chemical solution plate 30 is reduced. Thus, according to the present technology, the catalyst metal solution 20 can be highly efficiently introduced into the base material 10 with a desired width. According to the study by the present inventors, the variation of the amount of the catalyst metal solution 20 remaining on the chemical solution plate 30 becomes small. In other words, the catalyst metal solution 20 can be introduced into the base material 10 with high reproducibility. This can further improve quality stability.

An average of the depths D (see FIG. 3) of the grooves 32b of the chemical solution plate 30 is, for example, 1.2 mm or more, preferably 1.3 mm or more, more preferably 1.35 mm or more, yet more preferably 1.39 mm or more. The greater the depth D of each groove 32b, the more the surface tension of the catalyst metal solution 20 can be reduced. Although not particularly limited thereto, the average of the depths D of the grooves 32b is, for example, 5 mm or less, preferably 4 mm or less, more preferably 3 mm or less. If the depths D of the grooves 32b are too large, the amount of the catalyst metal solution 20 remaining in the chemical solution plate 30 after introducing the catalyst metal solution 20 into the base material 10 will be too large, which is disadvantageous in terms of costs. The depth D of the groove 32b refers to the distance from the deepest portion of the groove 32b to the level of the bottom surface 32a of the chemical solution plate 30 in the cross section along the width direction of the groove 32b.

The average of the widths W (see FIG. 5) of the grooves 32b in the chemical solution plate 30 is, for example, 1.6 mm or more, preferably 1.8 mm or more. IF the width W of the groove 32b is too small, the surface tension of the catalyst metal solution 20 may not be sufficiently reduced. Although not particularly limited thereto, the average of the widths W of the grooves 32b is, for example, 5 mm or less, preferably 4 mm or less, more preferably 3 mm or less, 2.2 mm or less, or 2 mm or less. If the width W of the groove 32b is too large, the amount of the catalyst metal solution 20 remaining on the chemical solution plate 30 after introducing the catalyst metal solution 20 to the base material 10 may become large.

Although not particularly limited thereto, in plan view, the proportion of the area of the grooves 32b in the bottom surface 32a of the chemical solution plate 30 is, for example, 10% to 60%, preferably 30% to 50%. This allows further reduction in surface tension of the catalyst metal solution.

The grooves 32b of the chemical solution plate 30 are formed in a predetermined pattern, and are preferably communicated with each other. With such a configuration, when the amount of the catalyst metal carrying portion supplied to the chemical solution plate 30 becomes small (e.g., the amount below the height of the bottom surface 32a), the liquid levels of the catalyst metal solution 20 in the grooves 32b become uniform. Thus, the waviness of the carrying width of the catalyst metal carrying portion can be further reduced.

In the present embodiment, as shown in FIG. 4, the grooves 32b of the chemical solution plate are formed in a lattice pattern. In other words, the grooves 32b include multiple grooves formed at a predetermined pitch P (the distance between adjacent grooves) toward the predetermined direction and multiple grooves formed at a predetermined pitch so as to intersect the grooves at a predetermined angle (here, 90°) (see FIG. 5). This allows further reduction in surface tension of the catalyst metal carrying portion, so that the waviness of the carrying width of the catalyst metal carrying portion can be reduced.

The pitch P of the grooves 32b is not particularly limited thereto, but is, for example, 6 mm or more, preferably 8 mm or more. The pitch P of the grooves 32b is, for example, 20 mm or less, preferably 14 mm or less, more preferably 10 mm or less. With such a range, the amount of the catalyst metal solution 20 remaining on the chemical solution plate 30 after introducing the catalyst metal solution 20 into the base material 10 becomes small, or the variation of the amount becomes small.

In the present embodiment, the grooves are formed such that the pitch of the grooves formed toward a predetermined direction becomes the same as the pitch of the grooves formed to intersect the grooves. In other words, in planar view, the grooves are formed such that the outside shapes of the bottom surfaces 32a surrounded by the grooves 32b become squares having sides with the same length. However, the present disclosure is not limited thereto, and the grooves can be formed as the pitch of the grooves formed toward a predetermined direction becomes different from the pitch of the grooves formed to intersect the grooves. In such a case, it is preferable that the pitch of the grooves formed toward a predetermined direction and the pitch of the grooves formed to intersect the grooves are within the range of pitch P of the grooves 32b.

In the present embodiment, the grooves are formed such that the cross-sectional shapes of the grooves 32b (the outside shapes of the grooves 32b) in the cross section along the width direction of the grooves 32b become inverted triangular shapes with gradually decreasing width toward the bottoms of the grooves. With such a configuration, the amount of the catalyst metal solution 20 remaining on the chemical solution plate 30 after introducing the catalyst metal solution 20 into the base material 10 becomes small, and the variation of the catalyst metal carrying amount in the catalyst metal carrying portion can be reduced. However, the cross-sectional shapes of the grooves 32b are not limited and may be semicircular, quadrangular, polygonal, or the like.

As shown in FIG. 4, in the present embodiment, the outside shape of the depression 36 of the chemical solution plate 30 is circular in plan view. However, the outside shape of the depression 36 is not particularly limited and may be ellipse, polygonal, or the like. The outside shape of the depression 36 in a plan view is preferably the same as the outside shape of the cross section perpendicular to the cylinder axis direction of the base material 10. With such an outside shape, the catalyst metal solution 20 can be more uniformly introduced into the base material 10. Thus, the waviness of the carrying width of the catalyst metal carrying portion is reduced.

The chemical solution plate 30 preferably has chemical resistance to the compound contained in the catalyst metal solution 20 used. Although the material of the chemical solution plate 30 may differ according to the type of the compound contained in the catalyst metal solution 20, it is, for example, stainless steel, vinyl chloride, and acrylic resin.

The chemical solution plate disclosed herein may be in a form of jig having a depression into which the catalyst metal solution can be supplied as long as the production processes disclosed herein can be conducted.

The material preparation step S10 includes supplying a catalyst metal solution 20 to a chemical solution plate 30. Specifically, the catalyst metal solution 20 is added to the depression 36 of the chemical solution plate 30, and is supplied such that the bottom surface 32a of the chemical solution plate 30 is not exposed. At this time, when there is an exposing portion of the bottom surface 32a of the chemical solution plate 30, the amount of the catalyst metal solution 20 introduced is small, or no catalyst metal solution 20 is introduced when the end of the base material 10 is immersed in the catalyst metal solution 20, which is not preferable.

Although not particularly limited thereto, the height H of the liquid surface of the catalyst metal solution 20 supplied to the chemical solution plate 30 (see FIG. 3) is preferably 0.37 mm or more. With such a configuration, curving of the liquid surface of the catalyst metal solution 20 supplied to the chemical solution plate 30 is reduced, and can be more flat. Thus, the waviness of the carrying width of the catalyst metal carrying portion can be reduced at higher level. The upper limit of the height H of the liquid surface is not particularly limited and can be adjusted, as appropriate, according to the desired carrying width of the catalyst metal carrying portion, but can be, for example, 300 mm or less. The height H of the liquid surface refers to a height from the bottom surface 32a.

### <Immersion Step S20>

In the immersion step S20, the end (the upstream end 10a or the downstream end 10b) of the base material 10 is immersed in the catalyst metal solution 20 supplied to the chemical solution plate 30. The base material 10 has an exhaust gas passage through which exhaust gas passes from the upstream end 10a to the downstream end 10b. Thus, the catalyst metal solution 20 supplied to the chemical solution plate 30 can be introduced into the exhaust gas passage.

The immersion time is not particularly limited because it is changed according to the carrying width of the catalyst metal carrying portion formed or the amount of the catalyst metal solution 20 supplied to the chemical solution plate 30, but is, for example, 5 seconds to 3 hours, or 10 minutes to 2 hours.

### <Drying Step S30>

The drying step S30 can be performed under the conditions similar to those which have been used in this kind of technology, and is not particularly limited. The heating temperature in the drying process is, for example, 50° C. to 200° C., preferably 100° C. to 150° C. The drying time is 0.5 hours to 5 hours, preferably 1 hour to 3 hours. The drying step S30 is not necessarily included and can be omitted.

### <Firing Step S40>

In the firing step S40, the base material 10 into which the catalyst metal solution 20 has been introduced is fired to form a catalyst metal carrying portion of the base material 10. When the catalyst metal solution 20 contains catalyst metal ions, the catalyst metal particles are deposited by the firing, and the catalyst metal particles can be adhered to a carrier (typically the partitions 14 of the base material 10). The firing conditions are not particularly limited, and can be controlled, as appropriate, according to the structure of the base material 10 and the composition of the catalyst metal solution. The firing temperature may be, for example, 150° C. or more, 200° C. or more, or 250° C. or more. The upper limit of the firing temperature may be 1000° C. or less, 900° C. or less, 800° C. or less, 700° C. or less, or 600° C. or less. The firing time may be 5 minutes or more, 0.5 hours or more, 1 hour or more, or 1.5 hours or more. The upper limit of the firing time may be 8 hours or less, 6 hours or less, or 4 hours or less.

Although, the main processes included in the production method according to the present embodiment have been described above, the production method disclosed herein may further include other processes at any stage. For example, a step of introducing a catalyst metal-containing slurry having desired composition and forming a catalyst layer at a position different from the catalyst metal carrying portion may be included. This allows improvement in exhaust gas purification performance of the exhaust gas purification catalyst. Specific composition or arrangement of the catalyst layer does not characterize the present technology. Thus, detailed description thereof is omitted.

The production method disclosed herein is suitably utilized when a defined amount of the catalyst metal carrying portion is formed in a defined width of the base material. According to the present technology, waviness of the carrying width of the catalyst metal carrying portion can be reduced. Thus, the difference in exhaust gas purification performance between the center portion and the outer peripheral portion of the base material can be reduced. The present technology can be implemented easily because it does not require the use of suction device or other devices.

The present disclosure further provides a chemical solution plate with the configuration described above, used in production of exhaust gas purification catalyst for purifying exhaust gas exhausted from internal combustion engines. The chemical solution plate disclosed herein can be used for other purpose in addition to the production processes disclosed herein.

The exhaust gas purification catalyst produced by using the present technology is installed in exhaust systems of internal combustion engines of vehicles, and can be used suitably for purification of exhaust gas exhausted from various internal combustion engines. For example, the exhaust gas purification catalyst can be used suitably as an exhaust gas purification catalyst for gasoline engines or diesel engines.

The following describes test examples of the technology disclosed herein. The following description is not intended to limit the technology disclosed herein to the test examples.

### <Preparation of Base Material and Catalyst Metal Solution>

As a base material, a straight flow type, cylindrical honeycomb base material (made of cordierite, length in cylinder axis direction: 100 mm, diameter: 117 mm, and cell density: 750 cpi) was prepared. As a catalyst metal solution, a palladium nitrate solution (Pd equivalent amount: 13.5 mass %) was prepared.

### <Preparation of Chemical Solution Plate>

### Examples 1 to 8

In each Example, a chemical solution plate including a circular (diameter: 130 mm) bottom surface and grooves in a lattice pattern formed in the bottom surface was prepared. The depth, width, and pitch of the groove in the chemical solution plate of each Example are as shown in Table 1. Note that the angle at which the grooves intersect each other was made to be a right angle. The cross-sectional shape of each groove along the width direction of the groove was an inverted triangle shape such that the width gradually decreases toward the apex of the bottom of the groove.

### Reference Example

As a Reference Example, a chemical solution plate including a circular (diameter: 130 mm) bottom surface with no groove was prepared.

### <Immersion of Base Material>

To the chemical solution plate, 6 g of catalyst metal solution was added. At this time, in each Example, it was confirmed that the chemical solution plate was filled with the catalyst metal solution so that the entire bottom surface of the chemical solution plate is not exposed. In Example 8 where the volume of the grooves was highest among Examples 1 to 8, the liquid level of the catalyst metal solution from the bottom surface of the chemical solution plate was 0.37 mm. Then, the end (i.e., an end surface of a cell having an opening) of the base material in the cylinder axis direction was immersed in the catalyst metal solution in the chemical solution plate, and the catalyst metal solution was introduced into the base material by the capillary phenomenon. The time required for the immersion was 5 seconds. Thereafter, a heat treatment was performed at 220° C. for 5 minutes, thereby producing an exhaust gas purification catalyst having a catalyst metal carrying portion.

In the Examples, exhaust gas purification catalysts were produced by changing the amount of the catalyst metal solution added to the chemical solution plate to 8 g, 10 g, and 16 g. In other words, four exhaust gas purification catalysts were produced in the Examples.

### <Evaluation of Waviness>

After the heat treatment of the exhaust gas purification catalysts produced, a portion carrying Pd turns black. The exhaust gas purification catalyst was divided into two sections along the cylinder axis direction so as to pass through the center of the end surface of the exhaust gas purification catalyst, the longest width portion and the smallest width portion in the cylinder axis direction in the black cross-sectional portion were measured, and the difference was determined as “waviness.” The average value of the waviness in four exhaust gas purification catalysts produced in each Examples is shown in Table 1.

### <Evaluation of Remaining Amount of Catalyst Metal Solution>

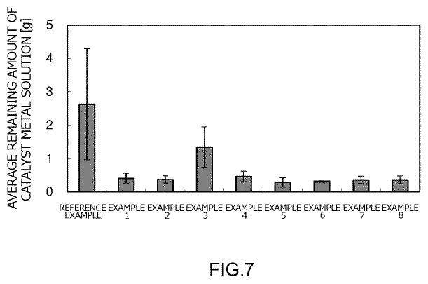

After the base material was immersed in the catalyst metal solution, the amount of the catalyst metal solution remaining in the chemical solution plate was measured by electronic scale. The measurement was performed on four exhaust gas purification catalysts produced in each Example, and the standard deviation S was calculated based on the following equation (1). In the equation (1), n indicates the data number (here, n=4), xi indicates each data value, and x_{ave.} indicates an average of each data. Then, the variation σ of data in each Example was determined by σ=3S. The average remaining amount (g) of the catalyst metal solution in each Example and its variation σ are shown in Table 1 and FIG. 7. FIG. 7 is a graph where the vertical axis indicates an average remaining amount of the catalyst metal solution in each Example, and the variation σ was indicated as an error bar.

$$[ Math . 1 ]$$

$$S = \sqrt{\frac{1}{n} {\sum }_{i = 1}^{n} {( {x}_{i} - {x}_{ave .} )}^{2}} \qquad ( 1 )$$

TABLE 1

| | Groove | Groove | Groove | Average Remaining | | |
|---|---|---|---|---|---|---|
| | Depth | Width | Pitch | Amount of Catalyst | Variation | Waviness |
| | (mm) | (mm) | (mm) | Metal Solution (g) | σ | (mm) |
| Reference | 0 | 0 | 0 | 2.63 | 1.668 | 3.5 |
| Example | | | | | | |
| Example 1 | 1.39 | 1.6 | 8 | 0.41 | 0.151 | 1 |
| Example 2 | 1.39 | 1.6 | 14 | 0.37 | 0.108 | 1 |
| Example 3 | 1.39 | 1.6 | 20 | 1.34 | 0.608 | 1 |
| Example 4 | 2 | 2 | 8 | 0.46 | 0.159 | 0 |
| Example 5 | 1 | 1.15 | 8 | 0.28 | 0.146 | 3.5 |
| Example 6 | 1.39 | 2 | 8 | 0.32 | 0.039 | 1 |
| Example 7 | 1.39 | 3 | 8 | 0.36 | 0.113 | 1 |
| Example 8 | 3 | 2 | 8 | 0.36 | 0.121 | 1 |

As can be seen from Table 1, in Reference Example where a chemical solution plate including a bottom surface with no groove was used, the waviness of the catalyst metal carrying portion was large. As can be seen from Example 4, even when the chemical solution plate including a bottom surface with grooves was used, if the depth and width of each groove were relatively small, the waviness of the catalyst metal carrying portion was not reduced. In contrast, in the case where the chemical solution plate with grooves having a depth of approximately 1.2 mm to 3 mm and a width of 1.6 mm to 3 mm was used (Examples 1 to 4 and 6 to 8), the waviness of the catalyst metal carrying portion was reduced. In particular, since, in Example 4, the waviness of the catalyst metal carrying portion was not caused, it was confirmed that waviness can be suitably reduced when the depth and width of each groove were both approximately 1.8 mm to 2.2 mm.

As can be seen from Table 1 and FIG. 7, comparing Reference Example and Examples 1 to 8, the remaining amount of the catalyst metal solution in the chemical solution plate was smaller and its variation was also smaller in Examples 1-8, indicating that the use of the chemical solution plate including a bottom surface with grooves enables highly efficient carrying of the catalyst metal on the base material. Comparing Examples 1 to 3, it was confirmed that when the pitch of the grooves was 8 mm to 14 mm, the remaining amount of the catalyst metal solution and its variation can be smaller.

Although specific examples of the present technology have been described in detail above, they are mere examples and do not limit the appended claims. The technology described in the appended claims include various modifications and changes of the foregoing specific examples.

1. A method for producing an exhaust gas purification catalyst that purifies exhaust gas exhausted from an internal combustion engine, the method comprising:
preparing a base material having an exhaust gas passage extending from an upstream end from which exhaust gas is introduced to a downstream end from which exhaust gas is exhausted;
preparing a catalyst metal solution containing a catalyst metal functioning as a catalyst capable of oxidizing or reducing at least one exhaust gas component;
supplying the catalyst metal solution to a chemical solution plate so that a bottom surface of the chemical solution plate is not exposed;
immersing an upstream end or a downstream end of the base material in the catalyst metal solution supplied to the chemical solution plate to introduce the catalyst metal solution to an exhaust gas passage of the base material; and
firing the base material into which the catalyst metal solution is introduced, wherein
the bottom surface of the chemical solution plate is provided with grooves in a predetermined pattern, an average of depths of the grooves is from 1.2 mm to 3 mm inclusive, and an average of widths of the grooves is from 1.6 mm to 3 mm inclusive.

2. The method according to claim 1, wherein
a liquid surface of the catalyst metal solution supplied to the chemical solution plate, from the bottom surface is 0.37 mm or more.

3. The method according to claim 1, wherein
the grooves are formed to communicate with each other.

4. The method according to claim 3, wherein
the grooves are formed in a lattice pattern.

5. The method according to claim 4, wherein
the grooves are formed at a predetermined pitch, and the pitch is from 8 mm to 20 mm inclusive.

6. A chemical solution plate used in production of an exhaust gas purification catalyst that purifies exhaust gas exhausted from an internal combustion engine, the chemical solution plate comprising:
a depression including a bottom wall and a side wall standing from the bottom wall, wherein
a surface of the bottom wall on a side of the depression is provided with grooves in a predetermined pattern,
an average of depths of the grooves is from 1.2 mm to 3 mm inclusive, and
an average of widths of the grooves is from 1.6 mm to 3 mm inclusive.

7. The method according to claim 2, wherein
the grooves are formed to communicate with each other.

8. The method according to claim 7, wherein
the grooves are formed in a lattice pattern.

9. The method according to claim 8, wherein
the grooves are formed at a predetermined pitch, and the pitch is from 8 mm to 20 mm inclusive.
